(19) United States
(12) Patent Application Publication
(10) Pub. No.: US 2026/0019750 A1
(43) Pub. Date: Jan. 15, 2026

(54) SPEAKER WITH A VIBRATION SYSTEM

(71) Applicants: Yiu Hung Yeung, Tsung Wan (HK); Ngai Fun Cheung, Tsung Wan (HK)

(72) Inventors: Yiu Hung Yeung, Tsung Wan (HK); Ngai Fun Cheung, Tsung Wan (HK)

(21) Appl. No.: 18/772,909

(22) Filed: Jul. 15, 2024

(51) Int. Cl. H04R 7/12; H04R 7/18; H04R 9/02; H04R 9/06

(52) U.S. Cl. CPC H04R 7/12; H04R 7/18; H04R 9/025; H04R 9/06

(57) ABSTRACT

A speaker with a vibration system includes an acoustic unit, a vibration unit and a bracket. The vibration unit and the acoustic unit are mounted on the bracket, and the vibration unit is arranged in front of the acoustic unit. The vibration unit provides a vibration plate and a vibration component. The vibration component drives the vibration plate to generate vibration and transmits to the ear through the bracket. The vibration signal generated by the vibration plate is converted from the audio signal of the acoustic unit to can keep in sync with the sound emitted by the acoustic unit. The vibration is closer to the audio than the use of vibration motor, etc. In addition, the vibration unit is arranged in front of the acoustic unit, the vibration signal can be directly transmitted to the ear to the maximize sound and vibration output to the user.

### FIELD OF THE INVENTION

The present invention relates to a speaker system, in particular to a speaker system which generates tactile feedback by using a vibration system.

### BACKGROUND OF THE INVENTION

Throughout history, humans always find ways to entertain themselves. These methods are as varied as the stars in the sky, ranging from storytelling to virtual reality. However, what remains consistent is that humans always use contemporary technology to further enhance the entertainment experience. Take virtual reality as an example, where the user puts on the headphone to keep out the external environment, and immerses into a computer-generated reality. But unfortunately, the immersion of this reality is dependent on the supported technology, and relies on effective audio and video output systems. To further immerse them into the virtual world, one way is to provide tactile feedback that corresponds to events in the virtual environment. The traditional system uses a vibration device to achieve. Some of them integrate the vibration device into the speaker system. It saves space, but it often causes distortion of the speaker's audio output. The acoustic driver and the vibration device operating in a closed cabinet cause a high-pressure environment due to the air pressure generated by the vibration device and the acoustic driver's diaphragm. The high-pressure environment limits the oscillation of the diaphragm. So, the audio is distorted, affecting the immersive experience and reducing the overall entertainment value.

### SUMMARY OF THE INVENTION

In view of the shortcomings of the above-mentioned prior art, the present invention solves audio distortion problem in speakers with integrated tactile feedback systems. In order to realize the function, the present invention designs a speaker system by changing the arrangement and structure of the speaker and the vibration system. The vibration system will not generate additional air pressure during vibration, and the sound waves generated by the acoustic unit can penetrate the vibration system without any obstruction. It will not affect the audio, ensuring high-fidelity audio playback and achieving tactile feedback effects.

A speaker with a vibration system, wherein comprising:
an acoustic unit, a vibration unit and a bracket;
the vibration unit and the acoustic unit being mounted on the bracket, and
the vibration unit being arranged in front of the acoustic unit;
the vibration unit being provided with a vibration plate and a vibration component, the vibration component driving the vibration plate to generate vibration and transmitting the vibration to an ear through the bracket;
the vibration plate being provided with first through holes for allowing the sound emitted by the acoustic unit to penetrate.

Further, the vibration component comprises a magnetic part and a driving coil cooperated with, and the vibration plate is fixed to the magnetic part or the driving coil.

Further, the magnetic part comprises a magnet, a ferromagnet attached to the magnet, a ferromagnetic cover housing the magnet and the ferromagnet inside, a gap is provided between rims of the magnet and the ferromagnet and an inner wall of the ferromagnetic cove; and the drive coil is placed in the gap.

Further, the vibration plate comprises an outer ring and a vibration part disposed in the outer ring; the vibration part is connected to the outer ring through a plurality of supporting parts; the first through holes for sound penetrating is arranged between the support parts.

Further, the support part is an elastic sheet in arc shaped connected the outer ring and the vibration part.

Further, the width of the two ends of the elastic sheet connected to the outer ring and the vibration part increases.

Further, the bracket is annular, the acoustic unit is embedded on the bottom of the annular bracket, and the vibration part is installed on the top of the annular bracket.

Further, a front cover is provided and the driving coil is fixed on, the vibration plate is fixed to magnetic part.

Further, the front cover is provided with second through holes for sound penetrating emitted by the acoustic unit.

Further, a connection column is provided on the bottom of the magnetic part, the vibration plate is provided with a connection hole corresponding to the connection column, the connection column inserts into the connection hole and connects with a clamp to fix the vibration plate to the bottom of the magnetic part through the connection column.

The beneficial effects of the embodiment of the present invention are: the present invention solves audio distortion problem in speakers with integrated tactile feedback systems. In order to realize the function, the present invention designs a speaker system by changing the arrangement and structure of the speaker and the vibration system. The vibration unit is arranged in front of the acoustic unit. and, the first through holes are provided on the vibrating plate to allow the sound emitted by the acoustic unit to penetrate and will not be blocked by the vibration unit to enter the ear, and the vibrating plate will not generate additional air pressure during the vibration process, or even if any air pressure, the pressure is low and can be released through the first through holes, so that it will not affect the sound generated by the acoustic unit to ensures high-fidelity audio playback and matching tactile feedback effects.

### BRIEF DESCRIPTION OF THE DRAWINGS

The present invention will be further described below in conjunction with the accompanying drawings:

FIG. 1 is a front view of the present invention.

FIG. 2 is a section view of the present invention.

FIG. 3 is an exploded view of the present invention.

FIG. 4 is an exploded view of the present invention from the other perspective.

### DESCRIPTION OF THE EMBODIMENTS

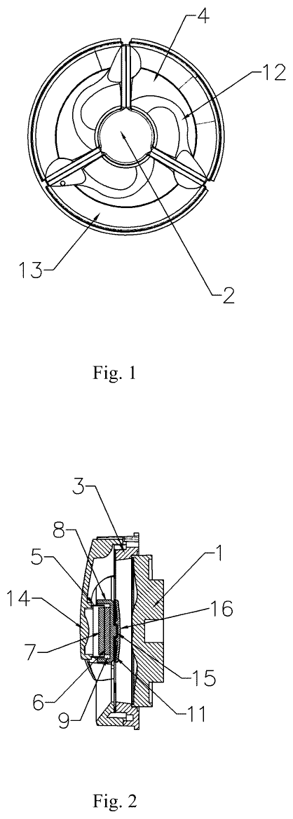

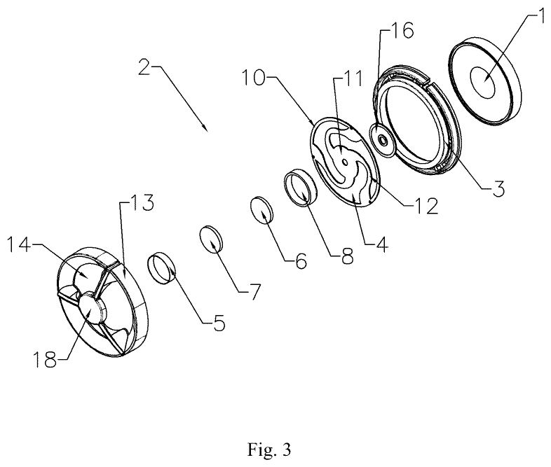

Referring to FIG. 1 and FIG. 2, a speaker with a vibration system, comprises an acoustic unit 1, a vibration unit 2 and a bracket 3. The vibration unit 2 and the acoustic unit 1 are mounted on the bracket, and the vibration unit 2 is arranged in front of the acoustic unit 1. The vibration unit 2 is provided with a vibration plate and a vibration component. The vibration component drives the vibration plate to generate vibration and transmitting the vibration to an ear through the bracket 3. The vibration plate is provided with first through holes 4 for allowing the sound emitted by the acoustic unit 1 to penetrate.

To prevent the vibration unit 2 from blocking the sound from entering the ears which is emitted by the acoustic unit 1 located behind, and reduce the air pressure change by the vibration unit 2 during the vibration process and thereby produce audio distortion, the present invention provides a vibrating plate with the first through holes 4 to let the sound generated y the acoustic unit 1 to penetrate through. Firstly, the vibration signal of the vibrating component is synchronized with the audio signal of the acoustic unit 1, then the vibration generated by the vibrating plate is also synchronized with the sound generated by the acoustic unit 1. So, the vibration of the vibrating plate will not affect the sound of the acoustic unit 1 to cause audio distortion. The first through holes 4 not only allow the sound directly penetrate into the ear, but also prevents the vibrating plate from forming a closed cavity with other components to generate a high air pressure during vibration and interfere with sound propagation.

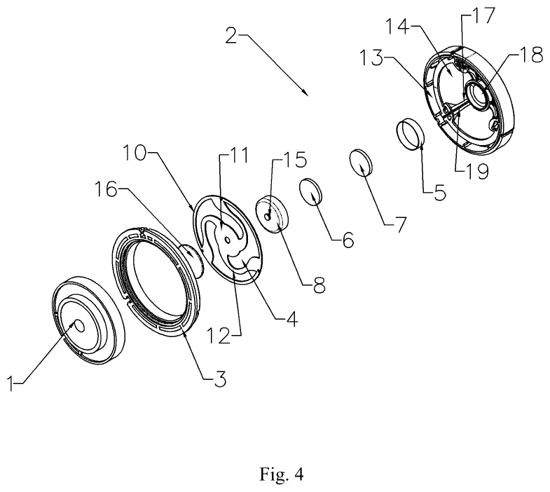

In order to realize that the vibrating component can be driven synchronously by audio signals to form tactile feedback, the vibrating component includes a magnetic part and a driving coil 5 cooperated with, and the vibrating plate is fixed to the magnetic part or the driving coil 5. Referring to FIG. 2, FIG. 3 and FIG. 4, the overall structure of the vibrating component is very close to the structure of the acoustic unit, except that the power of the vibration drive signal for driving the vibrating component will be relatively big. So, the audio signal will be amplified through a power amplifier and then input to the vibration component to drive. The drive coil 5 is placed in the magnetic field of the magnetic part. When the vibration drive signal is input to the drive coil 5, a corresponding magnetic field change accordingly. The drive coil 5 interacts with the magnetic field of the magnetic part and move to generate vibration signals.

Specifically, the magnetic part includes magnet 6. In order to increase and improve the distribution of magnetic field lines of the magnetic 6, a ferromagnet 7 is attached to the magnetic 6. A ferromagnetic cover 8 is provided. The magnet 6 and the ferromagnet 7 are placed in the ferromagnetic cover 8 and the magnet 6 is contacted with the inner bottom surface of the ferromagnetic cover 8. A gap 9 is set between the rims of the magnet 6 and the ferromagnet 7 and the inner wall of the ferromagnetic e cover 8, referring to FIG. 2. Such design can guide the magnetic field lines of the magnet 6 through the ferromagnet 7 and the ferromagnetic cover 8 to the gap 9, and the drive coil 5 is placed in the gap 9 to improve the response of the entire vibrating component.

In order to increase the vibration amplitude of the vibrating plate, the vibrating plate includes an outer ring 10 and a vibrating part 11 disposed in the outer ring 10, referring to FIG. 3 and FIG. 4. The outer ring 10 facilitates the installation and fixation of the vibration plate with the bracket 3. The vibration part 11 connects to the outer ring 10 through a plurality of supporting parts. The supporting parts can hold the vibrating plate 11, and the width of the supporting part is narrow and the elastic modulus is relatively low, so that the vibrating part 11 can be easily driven by the vibrating component. Firstly, the response sensitivity of the vibrating part 11 is improved, and further, the amplitude of vibrating part 11 is raised. At the same time, the first through holes 4 for penetrating sound is formed between the supporting parts. And Narrow width of supporting parts can reduce the impact on sound.

Furthermore, the supporting part preferably adopts an elastic piece in arc shaped to make the supporting part with more length to improve its elastic deformation ability in similarly area, that would further increase the amplitude of the vibrating part 11. The width of the two ends of the elastic sheet 12 connected to the outer ring 10 and the vibrating part 11 is increased to reduce the stress concentration at the connection point to prevent breakage.

In order to facilitate the assembly of the speaker with a vibration system, the bracket 3 is formed into an annular shape as a whole. The assembled vibration unit 2 and acoustic unit 1 can be conveniently fixed and installed with the annular bracket 3, referring to FIG. 3 and FIG. 4. The acoustic unit 1 is embedded at the bottom of the annular bracket 3, and the vibration part 11 is installed on the top surface of the annular bracket 3. The drive coil 5 is separated from the magnetic part, so they need to be installed and fixed. The preferred solution of the present invention is to connect the magnetic part, namely the magnet 6, the ferromagnet 7 and the ferromagnetic cover 8, to the vibrating plate. The outer ring 10 of the vibrating plate is fixed on the top of the annular bracket 3 for accommodating the large weight of the magnetic part, to get greater inertia when vibrating and making it easier to drive the vibrating plate work with greater amplitude. Then install the front cover 13 in front of the bracket 3, and the drive coil 5 is fixed on the front cover 13. It is also necessary to provide second through holes 14 on the front cover 13 for the penetration of the sound emitted by the acoustic unit 1. Specifically, the front cover 13 is also an annular design to match and install with the annular bracket 3. A mounting base 18 for installing the drive coil 5 is provided in the middle of the annular front cover 13. The mounting base 18 is connected to the annular front cover 13 by support ribs 17, and the bottom surface of the support ribs 17 is provided with slots 19 for wire arrangement, so that the drive coil 5 can be connected to the drive circuit through embedded wires. The second through holes 14 are formed between the support ribs 17.

In order to facilitate the installation of the magnetic part and the vibration plate, a connection column 15 is provided on the bottom of the magnetic part, and the vibration plate is provided with a connection hole corresponding to the connection column 15. The connection column 15 inserts into the connection hole and connects with a clamp 16 to fix the vibration plate to the bottom of the magnetic part through the connection column 15, referring to FIG. 3 and FIG. 4.

The above is only a preferred embodiment of the present invention. The invention is not limited to the above implementation. As long as the technical effect of the invention is achieved by the same means, any modification, equivalent replacement, improvement, etc. made within the spirit and principle of the disclosure shall be included in the scope of protection of the invention. All should belong to the protection scope of the invention. Within the protection scope of the invention, the technical solution and/or implementation method can have various modifications and changes.

1. A speaker with a vibration system, wherein comprising:
an acoustic unit, a vibration unit and a bracket;
the vibration unit and the acoustic unit being mounted on the bracket, and
the vibration unit being arranged in front of the acoustic unit;
the vibration unit being provided with a vibration plate and a vibration component, the vibration component driving the vibration plate to generate vibration and transmitting the vibration to an ear through the bracket;
the vibration plate being provided with first through holes for allowing the sound emitted by the acoustic unit to penetrate.

2. The speaker with a vibration system of claim 1, wherein the vibration component comprises a magnetic part and a driving coil cooperated with, and the vibration plate is fixed to the magnetic part or the driving coil.

3. The speaker with a vibration system of claim 2, wherein the magnetic part comprises a magnet, a ferromagnet attached to the magnet, a ferromagnetic cover housing the magnet and the ferromagnet inside, a gap is provided between rims of the magnet and the ferromagnet and an inner wall of the ferromagnetic cove; and the drive coil is placed in the gap.

4. The speaker with a vibration system of claim 1, wherein the vibration plate comprises an outer ring and a vibration part disposed in the outer ring; the vibration part is connected to the outer ring through a plurality of supporting parts; the first through holes for sound penetrating are arranged between the support parts.

5. The speaker with a vibration system of claim 4, wherein the support part is an elastic sheet in arc shaped connected the outer ring and the vibration part.

6. The speaker with a vibration system of claim 5, wherein the width of the two ends of the elastic sheet connected to the outer ring and the vibration part increases.

7. The speaker with a vibration system of claim 1, wherein the bracket is ring-shaped, the acoustic unit is embedded on the bottom of the ring-shaped bracket, and the vibration part is installed on the top of the ring-shaped bracket.

8. The speaker with a vibration system of claim 3, wherein a front cover is provided and the driving coil is fixed on, the vibration plate is fixed to magnetic part.

9. The speaker with a vibration system of claim 8 wherein the front cover is provided with second through holes for sound penetrating emitted by the acoustic unit.

10. The speaker with a vibration system of claim 8 wherein a connection column is provided on the bottom of the magnetic part, the vibration plate is provided with a connection hole corresponding to the connection column, the connection column inserts into the connection hole and connects with a clamp to fix the vibration plate to the bottom of the magnetic part through the connection column.
